(19) United States
(12) Patent Application Publication
(10) Pub. No.: US 2016/0033363 A1
(43) Pub. Date: Feb. 4, 2016

(54) METHOD, COMPUTER PROGRAM PRODUCT & SYSTEM

(71) Applicant: AKTIEBOLAGET SKF, Göteborg (SE)

(72) Inventors: Brian MURRAY, Aberdeen (GB); Allan THOMSON, Lanark (GB); Ivan ROCHFORD, Portmarnock (IE)

(73) Assignee: Aktiebolaget SKF, Göteborg (SE)

(21) Appl. No.: 14/782,364

(22) PCT Filed: Apr. 5, 2013
(86) PCT No.: PCT/EP2013/057175

§ 371 Date: Oct. 5, 2015

(51) Int. Cl. G01M 13/04; G06F 17/10; G06F 17/50

(52) U.S. Cl. CPC G01M 13/045; G06F 17/5009; G06F 17/10

(57) ABSTRACT

A method for processing data obtained from a condition monitoring system, the method comprising steps of obtaining one of a vibration enveloped or an acoustic emission envelope time waveform from at least one sensor, counting at least one of: (a) how many transient events cross a plurality of predetermined threshold levels within the time waveform, (b) a rate at which transient events cross a plurality of predetermined threshold levels within the time waveform, and (c) determining a periodicity of repetition of the transient events where applicable.

### CROSS REFERENCE TO RELATED APPLICATION

This is a United States National Stage Application claiming the benefit of International Application Number PCT/EP2013/057175 filed on 5 Apr. 2013, which is incorporated herein by reference in its entirety.

### TECHNICAL FIELD

The present invention concerns a method, system and computer program product for processing data obtained from a condition monitoring system, such a condition monitoring system for monitoring and optionally predicting the residual life of a component, such as a bearing, i.e. for predicting when it is necessary or desirable to service, replace or refurbish (re-manufacture) the component.

### BACKGROUND OF THE INVENTION

Condition monitoring is the process of determining the condition of machinery while in operation. Condition monitoring enables the repair of problem components prior to failure and not only helps plant personnel reduce the possibility of catastrophic failure, but also allows them to order parts in advance, schedule manpower, and plan other repairs during downtime.

Components such as rolling-element bearings are often used in critical applications, wherein their failure in service would result in significant commercial loss to the end-user. It is therefore important to be able to predict the residual life of such a bearing, in order to plan intervention in a way that avoids failure in service, while minimizing the losses that may arise from taking the machinery in question out of service to replace the bearing.

The residual life of a rolling-element bearing is generally determined by fatigue of the operating surfaces as a result of repeated stresses in operational use. Fatigue failure of a rolling element bearing results from progressive flaking or pitting of the surfaces of the rolling elements and of the surfaces of the corresponding bearing races. The flaking and pitting may cause seizure of one or more of the rolling elements, which in turn may generate excessive heat, pressure and friction.

Bearings are selected for a specific application on the basis of a calculated or predicted residual life expectancy compatible with the expected type of service in the application in which they will be used. However, this type of life prediction is considered inadequate for the purpose of maintenance planning for several reasons.

One reason is that the actual operation conditions may be quite different from the nominal conditions. Another reason is that a bearing's residual life may be radically compromised by short-duration transient events or unplanned transient events, such as overloads, lubrication failures, installation errors, etc. Yet another reason is that, even if nominal operating conditions are accurately reproduced in service, the inherently random character of the fatigue process may give rise to large statistical variations in the actual residual life of substantially identical bearings.

In order to improve maintenance planning, it is common practice to monitor the values of physical quantities related to vibrations to which a component, such as a bearing, is subjected in operational use, so as to be able to detect the first signs of impending failure.

In a condition monitoring system data dynamic signal data is obtained in the form of a time waveform (i.e. a graph of a varying quantity against time which usually consists of many samples) from at least one sensor. These time waveforms are usually transmitted and displayed to an analyst. This can however result in long transmission and display times and the data can be difficult to display or interpret. The transmission, display and interpretation of such data can require a significant amount of energy, time and expertise, and consequently decreases the rate at which measurements and analyses can be made.

There are condition monitoring systems using vibration level sensors in which only the “overall amplitudes” (i.e. the total amount of vibration occurring in a selected frequency range) of a particular signal are transmitted or displayed. However, such transmitted or displayed data has limited value since it provides no information about the nature of a signal. Additionally, no further information can be post-processed from the transmitted or displayed overall amplitude values.

### SUMMARY OF THE INVENTION

An object of the invention is to provide an improved method for processing data obtained from a condition monitoring system.

This object is achieved by a method comprising the steps of obtaining a vibration enveloped or an acoustic emission enveloped (AEE) (demodulated) time waveform from at least one sensor and counting how many transient events (hits or energy spikes) cross a plurality of predetermined threshold levels within the time waveform and/or counting the rate at which transient events cross a plurality of predetermined threshold levels within the time waveform, and/or determining a periodicity of repetition of said transient events where applicable, i.e. where a repetitive pattern of transient events is determined rather than a random occurrence of transient events. The counts or count rate may be used to provide information necessary for the assessment of at least one component being monitored by the condition monitoring system.

Counting how many transient cross a plurality of predetermined threshold levels and/or counting the rate at which transient events cross a plurality of predetermined threshold levels, and/or determining a periodicity of repetition of the transient events where applicable, within an enveloped time waveform, rather than on raw Acoustic Emission time waveforms, means that the method according to the present invention can be carried our very quickly without requiring expensive hardware or high processing power.

Vibration enveloping and Acoustic Emission Enveloping (AEE) have been developed to detect lubrication problems in lubricated mechanical components such as bearings and gears. This signal analysis technique can detect signs of potential problems before component damage actually occurs, further extending the warning time to failure, and allows for lubrication issues to be corrected prior to component damage occurring. Counts over several predetermined threshold levels may be provided in a simple histogram of transient event amplitudes which is more representative of the levels of distress than “overall amplitudes” provided in existing condition monitoring systems using vibration level sensors. Periodicity may be determined from the time waveforms. The periodicity may then be associated with specific mechanical sources.

According to a further embodiment of the invention the step of counting how many transient events cross a plurality of predetermined threshold levels within the time waveform and/or the step of counting the rate at which transient events cross a plurality of predetermined threshold levels within the time waveform is carried out from the zero or the mean of the time waveform. A vibration enveloped or an acoustic emission enveloped (demodulated) signal comprises a baseline part of the signal populated by spikes of relatively larger amplitude representing specific transient events in time. Counting can be carried out on the raw time waveform from the zero (if AC coupled) or the mean (if there is a DC offset) or from a time waveform that has been filtered (using reverse median or non-linear energy operator (NEO) filtering for example) so as to remove/reduce the transient changes in the DC offset (unsteady carpet level).

For each predetermined threshold level the number of instances that the time waveform crosses it with a rising edge only are counted. In applications where assessment of periodicity is a requirement, time stamps for each count may also utilised in an algorithm or a time difference histogram for all event permutations to provide a measure of periodicity versus random occurrence and also what these periods correlate to with respect to the component being monitored.

According to an embodiment of the invention the method comprises the step of filtering the time waveform and the step of counting how many transient events cross a plurality of predetermined threshold levels within the filtered time waveform and/or the step of counting the rate at which transient events cross a plurality of predetermined threshold levels within the time waveform is carried out on the filtered time waveform. The time waveform may be processed by band-pass filtering, demodulating and/or rectifying.

According to another embodiment of the invention the method comprises the step of transmitting and/or displaying the counts and/or count rate instead of transmitting and/or displaying the time waveform. Such a method avoids the need to transmit and/or display the whole time waveform data from dynamic signals and reduces the amount of data that needs to be transmitted by transmitting and/or displaying only part of the data provided by the at least one sensor, i.e. by extracting, transmitting and/or displaying only the counts and/or count rate. This leads to a significant reduction of the data that needs to be transmitted and/or displayed. Transmission, display and data processing times will therefore be shorter, less energy will be required for transmission, display and processing, which consequently results in extending the sensor battery life, or reducing the sensor battery size or power generation requirement.

A user will be more quickly warned of deterioration in the condition of a component being monitored and poor installation or poor operating practices, such as misalignment, imbalance, high vibration, lack of lubrication and contamination in the lubricant etc., which would reduce the residual life of the component if left uncorrected, will be more quickly identified.

According to an embodiment of the invention the method comprises the step of providing a histogram of transient event amplitudes.

According to another embodiment of the invention the method comprises the step of determining a modification factor to include in a life mode calculation.

According to a further embodiment of the invention the method the counts and/or count rate is/are transmitted wirelessly over a wireless communication network.

According to an embodiment of the invention the method comprises the step of electronically recording said counts and/or count rate in a database.

According to a further embodiment of the invention the condition monitoring system is arranged to monitor at least one bearing, such as a rolling element bearing. The rolling bearing may be any one of a cylindrical roller bearing, a spherical roller bearing, a toroidal roller bearing, a taper roller bearing, a conical roller bearing or a needle roller bearing.

The present invention also concerns a computer program product that comprises a computer program containing computer program code means arranged to cause a computer or a processor to execute the steps of a method according to any of the embodiments of the invention, stored on a computer-readable medium or a carrier wave.

The present invention further concerns a system for processing data obtained from a condition monitoring system comprising at least one sensor arranged to provide a vibration enveloped or an AEE time waveform. The system comprises a processing unit arranged to count how many transient events cross a plurality of predetermined threshold levels within the time waveform and/or count the rate at which transient events cross a plurality of predetermined threshold levels within the time waveform.

According to another embodiment of the invention the processing unit is arranged to determine a periodicity of repetition of the transient events where applicable.

According to a further embodiment of the invention the processing unit is arranged to count how many transient events cross a plurality of predetermined threshold levels within the time waveform and/or to count the rate at which transient events cross a plurality of predetermined threshold levels within the time waveform from the zero or the mean of the time waveform.

According to an embodiment of the invention the processing unit is arranged to filter the time waveform and counting how many transient events cross a plurality of predetermined threshold levels within the filtered time waveform and/or counting the rate at which transient events cross a plurality of predetermined threshold levels within the time waveform on the filtered time waveform.

According to another embodiment of the invention the system comprises a transmission unit to transmit and/or display means to display the counts and/or count rate instead of the time waveform.

According to an embodiment of the invention the system comprises transmission means to transmit the counts and/or count rate wirelessly over a wireless communication network.

According to another embodiment of the invention the processing unit is arranged to provide a histogram of transient event amplitudes.

According to a further embodiment of the invention the condition monitoring system is arranged to monitor at least one bearing, such as a rolling element bearing.

According to an embodiment of the invention the system may comprise a prediction unit configured to predict the residual life of a component such as a bearing, using the recorded data or transmitted and/or displayed data.

It should be noted that the method, computer program and system according to the present invention may be used to monitor at least one component, such as a bearing during the component's manufacture, after the component's manufacture and before the component's use, during the component's use, during a period when the component is not in use and/or during the transportation of the component. A complete history log of a component may thereby be created. Accordingly, as a result of having residual life data accumulated over the component's life, starting with its very manufacturing all the way up to the present, a more accurate prediction can be made regarding the residual life of an individual component at any point in its life-cycle. An analyst or end user may be notified of relevant facts including the time at which it is advisable to replace or refurbish the component.

The method, system and computer program product according to the present invention may be used to monitor at least one component, such as a bearing, used in automotive, aerospace, railroad, mining, wind, marine, metal producing and other machine applications which require high wear resistance and/or increased fatigue and tensile strength.

### BRIEF DESCRIPTION OF THE DRAWINGS

The present invention will hereinafter be further explained by means of non-limiting examples with reference to the appended figures where;

FIG. 1 shows a system according to an embodiment of the invention,

FIG. 2 is a flow chart showing the steps of a method according to an embodiment of the invention,

FIG. 3 shows examples of threshold counts,

FIG. 4 shows an example of transient event count trending,

FIG. 5 shows an example of periodicity assessment, and

FIG. 6 shows examples of non-linear energy operator (NEO) filtering of AEE signals.

It should be noted that the drawings have not been drawn to scale and that the dimensions of certain features have been exaggerated for the sake of clarity.

Furthermore, any feature of one embodiment of the invention can be combined with any other feature of any other embodiment of the invention as long as there is no conflict.

### DETAILED DESCRIPTION OF EMBODIMENTS

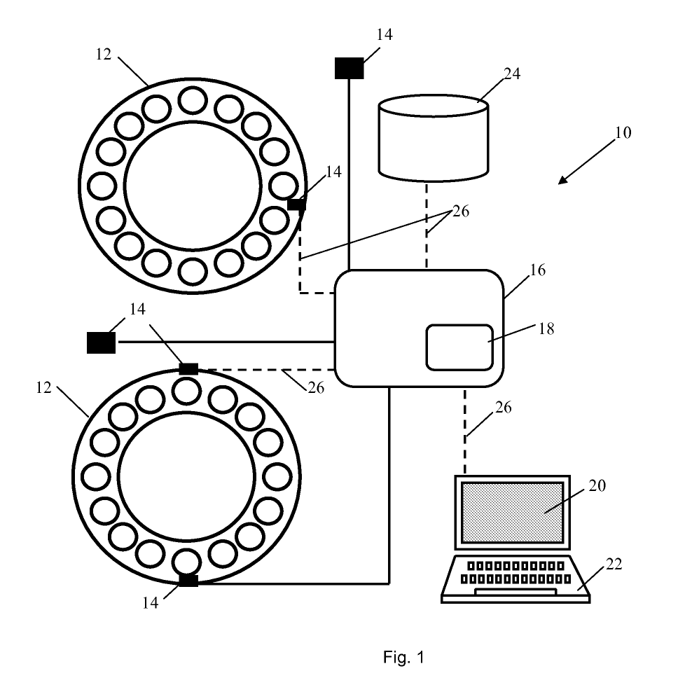

FIG. 1 shows a system 10 for monitoring the condition, and optionally predicting the residual life of a plurality of bearings 12 during their use. The illustrated embodiment shows two rolling element bearings 12, the system 10 according to the present invention may however be used to monitor the condition of one or more components of any type, and not necessarily all of the same type or size. The system 10 comprises a plurality of sensors 14 configured to provide an AEE time waveform for the assessment of the bearings 12. A sensor 14, such as an AE sensor, may be integrated with a bearing 12, placed in the vicinity of the bearing 12 or located remotely from the bearing. The sensors 14 may be configured to obtain data periodically, substantially continuously, randomly, on request, or at any suitable time.

The inner ring and/or outer ring of a bearing 12, which can be monitored using a system or method according to an embodiment of the invention, may be of any size and have any load-carrying capacity. An inner ring and/or an outer ring may for example have a diameter up to a few metres and a load-carrying capacity up to many thousands of tonnes.

The system 10 in the illustrated embodiment comprises a processing unit 16 arranged to count how many transient events cross a plurality of predetermined threshold levels within the time waveform and/or count the rate at which transient events cross a plurality of predetermined threshold levels within the time waveform. The system 10 also comprises transmission means 18 arranged to transmit the counts and/or count rate to a display means 20 and/or a device 22 used by a user or analyst and/or a database 24 where the at least two parameters may be electronically recorded. Data may be transmitted to and from the sensors 14, and to and from the processing means 16 in a wired or wireless (26) manner over a wireless communication network.

The database 20 may be maintained by the manufacturer of the bearings 12. The residual life data gathered in the database 20 for a whole batch of bearings 12 enables the manufacturer to extract further information, e.g., about relationships between types or environments of usage versus rates of change of residual life, so as to further improve the service to the end-user.

The system 10 may also comprise a prediction unit (not shown) configured to predict the residual life of each bearing 12 using the recorded data in the database 24 and a mathematical residual life predication model.

It should be noted that not all of the components of the system 10 necessarily need to be located in the vicinity of the bearings 12. For example, the database 24 and/or user device 22 may located at a remote location and communicate with at least one data processing unit 16 located in the same or a different place to the bearings 12 by means of a server for example.

It should also be noted that the at least one data processing unit 16, the transmission means 18 and/or the database 24 need not necessarily be separate units but may be combined in any suitable manner. For example a personal computer may be used to carry out a method concerning the present invention.

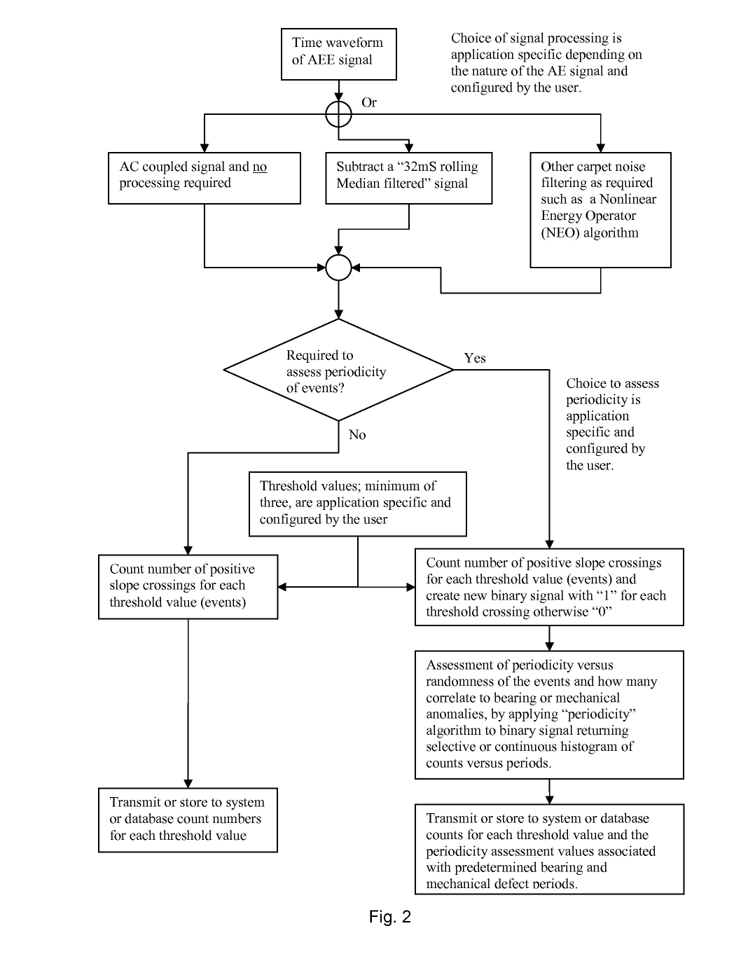

FIG. 2 is a flow chart showing the steps of a method according to an embodiment of the invention. In the method an AEE time waveform is obtained from a sensor 14 of a condition monitoring system 10 monitoring at least one component 12. An analyst can decide whether it is necessary to filter the signal, for example by subtracting a “32 mS rolling median filtered” signal, or to filter other carpet noise using a non-linear energy operator (NEO) algorithm for example, depending on the nature of the original AEE signal.

The common non-linear energy operator by Keiser & Teager may be used to filter a signal:

Neo[n]=x²[n]−x[n+1]*x[n−1]

The number of positive slope crossings (transient events) for each of a plurality of predetermined threshold values is counted, and the data is transmitted and/or displayed and/or recorded. The data may be transmitted wirelessly over a wireless network, in a wired manner, or in a combination of wired and wireless manners. The data may then be analysed or processed further to obtain condition status information concerning the at least one component being monitored and/or to understand the nature of the original time waveform and any defect(s) associated with it and the severity thereof.

If the periodicity of transient events within the time waveform is to be assessed, the number of positive slope crossings for each of a plurality of predetermined threshold values is counted and a new binary signal designated “1” is created for each positive slope crossing, otherwise a new binary signal designated “0” is created. Periodicity versus randomness of the transient events, and whether the transient events are correlated to component or mechanical anomalies may be assessed and the count or count rate data may be transmitted and/or displayed and/or recorded.

The data may be used to make a prediction of the residual life of a bearing 12. Once such a prediction has been made, it may be displayed on display means 20, and/or sent to a user device 22, bearing manufacturer, database 20 and/or another prediction unit. Notification of when it is advisable to service, replace or refurbish one or more bearings 12 being monitored by the system 10 may be made in any suitable manner, such as via a communication network, via an e-mail or telephone call, a letter, facsimile, alarm signal, or a visiting representative of the manufacturer.

The prediction of the residual life of a bearing 12 may be used to inform a user of when he/she should replace the bearing 12. Intervention to replace the bearing 12 is justified, when the cost of intervention (including labour, material and loss of, for example, plant output) is justified by the reduction in the risk cost implicit in continued operation. The risk cost may be calculated as the product of the probability of failure in service on the one hand, and the financial penalty arising from such failure in service, on the other hand.

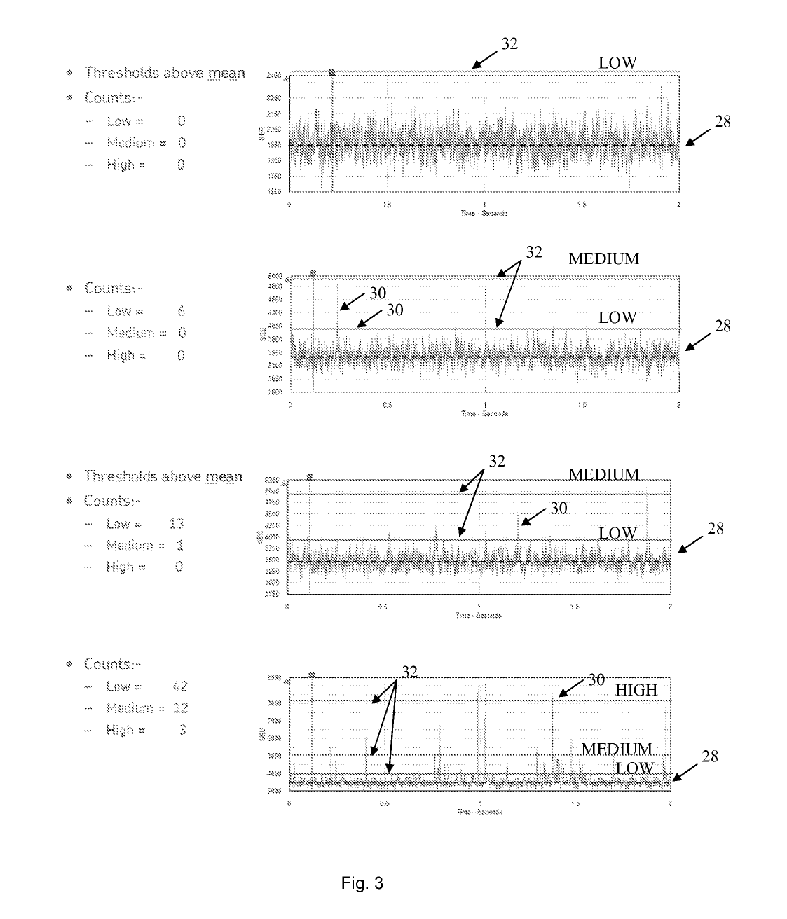

FIG. 3 shows examples of counts of transient events 30 above low, medium and high thresholds 32 within AEE time waveforms 28 obtained from a sensor 14 of a condition monitoring system according to the present invention. Analysis of AEE time waveforms 28 to determine said counts or count rate may be performed using standard condition monitoring tools.

The following threshold crossing counting algorithm (without periodicity assessment) may be used to count how many transient events cross a plurality of predetermined threshold levels within the time waveform:

```
T = threshold value
W = processed waveform array
Nos_counts = 0
Where N = number of samples in (W)
Repeat for I = 1 to N−1
      If W(I)<=T AND W(I+1)>T Then
            Nos_counts = Nos_counts + 1
      Else
            Nos_counts = Nos_counts
      EndIf
Next I
Return Nos_counts
```

Alternatively, the following threshold crossing counting algorithm with periodicity algorithm may be used to count how many transient events cross a plurality of predetermined threshold levels within the time waveform.

```
T = threshold value
W = processed waveform array
L = waveform acquisition length in seconds
Declare D as empty array of binary values
Declare Q as empty array of integers of counts for each period in
P (histogram)
P = array of periods of interest in seconds
B = array of +/−band in seconds
Nos_counts = 0
N = SIZE(W) ‘number of samples in W’
Repeat For I = 1 to N−1
      If W(I)<=T AND W(I+1)>T Then
            Nos_counts = Nos_counts + 1
            D(I) = 1
      Else
            Nos_counts = Nos_counts
            D(I) = 0
      EndIf
D(N) = 0
Next I
Concatenate(add) N samples of value “0” to end of “D” so D now has
2*N samples
Repeat For Z = 1 to SIZE(P)
      A= Round(P(Z)*L/(N−1))
      K= Round(B(Z)*L/(N−1))
      Repeat For x = (A−K) to (A+K) step 1
            E = Rotate(D,x) ‘array rotated by x samples’
            F = D*E
            K(x) = SUM(F) ‘sum of values in F’
      Next x
            Q(Z) = SUM(K)
      Next Z
      Return (Nos_counts, Q)
```

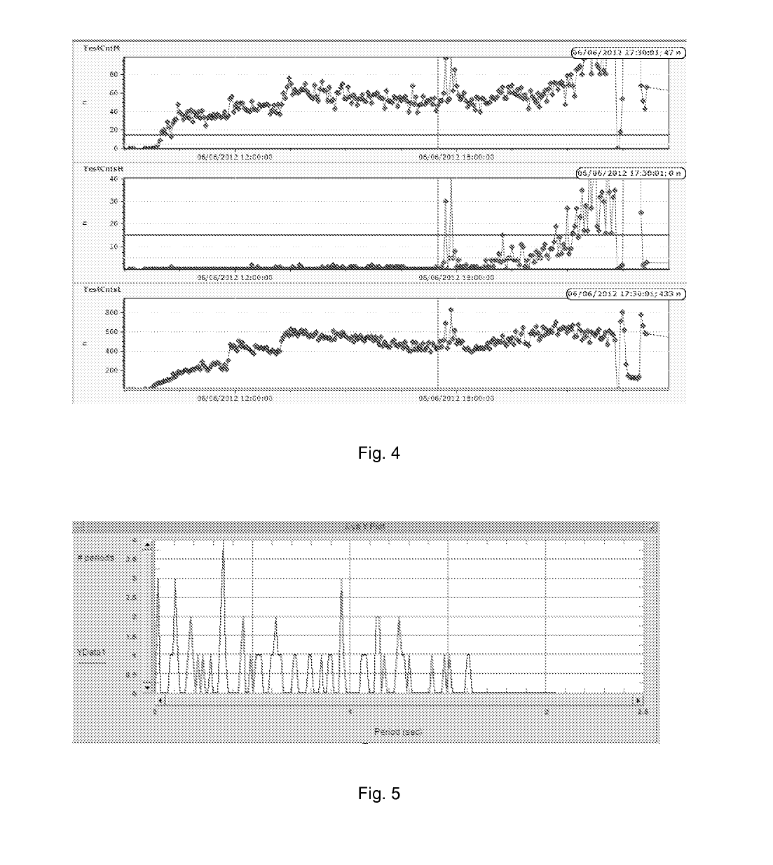

FIG. 4 shows that count data may be processed further to reveal trends and thereby provide further condition status information concerning the at least one component being monitored and to understand the nature of the original time waveforms from which they were extracted and any defect(s) associated with them and the severity thereof. FIG. 4 namely shows AEE transient event count trends for Low (bottom plot), Medium (top plot) and High (middle plot) threshold levels performed in SKF @ptitude Observer software during a period of time when a bearing suffered from lubrication starvation.

FIG. 5 shows a full (continuous) histogram displaying the distribution of the number of periods between any two transient events plotted against their period in seconds.

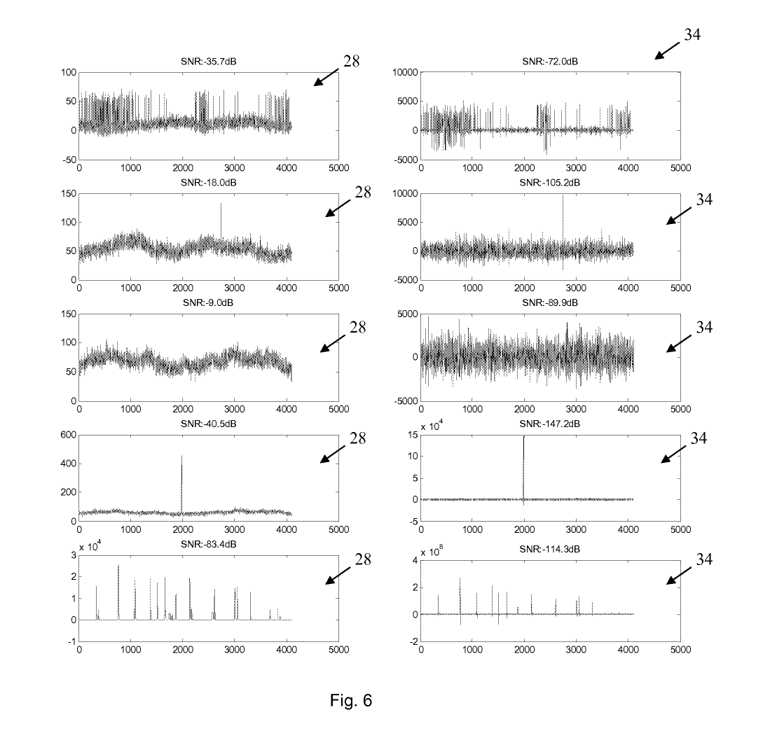

FIG. 6 shows examples of the common non-linear energy operator (NEO) filtering of AEE signals in order to enhance the signal to noise ratio and spike shape. FIG. 5 shows unconditioned/raw signals 28 on the left and NEO-enhanced signals, i.e. filtered signals 34, on the right. The signal-to-noise (SNR) ratio computed using 20 log(mean(signal))/NEO(signal) is provided above each plot.

Further modifications of the invention within the scope of the claims would be apparent to a skilled person. Even though the described embodiments are directed to a method, system and computer program product for monitoring at least one component such as a bearing, such a method, system and computer program product may be used for monitoring and optionally predicting the residual life of another component of rotating machinery, such as a gear wheel.

1. A method for processing data obtained from a condition monitoring system, the method comprising steps of:
obtaining a vibration enveloped or an acoustic emission envelope time waveform from at least one sensor; and
at least one of:
counting how many transient events cross a plurality of predetermined threshold levels within the time waveform,
counting the rate at which transient events cross a plurality of predetermined threshold levels within the time waveform, and
determining a periodicity of repetition of the transient events where applicable.

2. The method according to claim 1, wherein at least one of the following is carried out from one of a zero or a mean of the time waveform:
(a) the step of counting how many transient events cross a plurality of predetermined threshold levels within the time waveform, and
(b) the step of counting the rate at which transient events cross a plurality of predetermined threshold levels within the time waveform.

3. The method according to claim 1, further comprising a step of carrying out on the filtered time waveform, at least one of:
a step of filtering the time waveform,
the step of counting how many transient events cross a plurality of predetermined threshold levels within the filtered time waveform, and
the step of counting the rate at which transient events cross a plurality of predetermined threshold levels within the time waveform.

4. The method according to claim 1, the method further comprising a step of at least one of transmitting and displaying at least one of the counts and count rate instead of at least one of transmitting and displaying the time waveform.

5. The method according to claim 1, wherein the at least one of the counts and the count rate is transmitted wirelessly over a wireless communication network.

6. The method according to claim 1, the method further comprising a step of providing a histogram of transient event amplitudes.

7. The method according to claim 1, wherein the condition monitoring system is arranged to monitor at least one bearing.

8. A computer program product, comprising:
a computer program containing computer program code arranged to cause a computer or a processor to execute steps of:
obtaining a vibration enveloped or an acoustic emission envelope time waveform (28) from at least one sensor; and
at least one of:
counting how many transient events cross a plurality of predetermined threshold levels within the time waveform,
counting the rate at which transient events cross a plurality of predetermined threshold levels within the time waveform, and
determining a periodicity of repetition of the transient events where applicable,
wherein the computer program is stored on a computer-readable medium or a carrier wave.

9. A system for processing data obtained from a condition monitoring system including at least one sensor arranged to provide one of a vibration enveloped or an acoustic emission time waveform, the data processing system comprising:
a processing unit arranged to at least one of:
(a) count how many transient events cross a plurality of predetermined threshold levels within the time waveform,
(b) count the rate at which transient events cross a plurality of predetermined threshold levels within the time waveform, and
(c) determine a periodicity of repetition of the transient events where applicable.

10. The system according to claim 9, wherein the processing unit is arranged to at least one of:
count how many transient events cross a plurality of predetermined threshold levels within the time waveform, and
count the rate at which transient events cross a plurality of predetermined threshold levels within the time waveform from one of a zero or a mean of the time waveform.

11. The system according to claim 9, wherein the processing unit is arranged to filter the time waveform and at least one of:
count how many transient events cross a plurality of predetermined threshold levels within the filtered time waveform and/or
count the rate at which transient events cross a plurality of predetermined threshold levels within the filtered time waveform.

12. The system according to claim 9, further comprising a transmission unit to at least one of: transmit feature and a display feature to display at least one of the counts and the count rate instead of the time waveform.

13. The system according to claim 9, further comprising a transmission feature to transmit at least one of the counts and the count rate wirelessly over a wireless communication network.

14. A system according to claim 9, the processing unit is arranged to provide a histogram of transient event amplitudes.

15. A system according to claim 9, the condition monitoring system is arranged to monitor at least one bearing.

16. A system according to claim 9, the condition monitoring system is arranged to monitor at least one rolling element bearing.

17. A method according to claim 1, wherein the condition monitoring system is arranged to monitor at least one rolling element bearing.
